(19) United States
(12) Patent Application Publication
(10) Pub. No.: US 2015/0229628 A1
(43) Pub. Date: Aug. 13, 2015

(54) SYSTEM, METHOD AND ARCHITECTURE FOR PROVIDING INTEGRATED APPLICATIONS

(71) Applicants: Qamal Kosim-Satyaputra, Kingsford (AU); Philip Anthony Muir, Camperdown (AU); Cody George Lundquist, Rozelle (AU)

(72) Inventors: Qamal Kosim-Satyaputra, Kingsford (AU); Philip Anthony Muir, Camperdown (AU); Cody George Lundquist, Rozelle (AU)

(21) Appl. No.: 14/618,700

(22) Filed: Feb. 10, 2015

Related U.S. Application Data
(60) Provisional application No. 61/938,034, filed on Feb. 10, 2014.

(51) Int. Cl. H04L 29/06; G06F 9/445; H04L 29/08; G06F 21/12

(52) U.S. Cl. CPC H04L 63/08; G06F 21/121; G06F 8/61; H04L 63/0281; H04L 67/10; G06F 2221/2115

(57) ABSTRACT

A hosted application may be integrated into a multi-tenant system with minimal user efforts. Responsive to a first click from a user, an integrated applications container (IAC) may call an IAC proxy server requesting installation of the hosted application. The IAC proxy server may send an installation request to an application registry and receive an object containing an authorization universal resource locator (URL). The IAC proxy server may provide an interface to an authorization server and redirect the user's browser to the authorization URL. The authorization server may receive a second click from the user, indicating an authorization for the hosted application to access resources associated with the user in the multi-tenant system. The authorization server may operate to obtain an access token and communicating the authorization to the application registry which, in turn, may indicate completion of the installation of the hosted application into the multi-tenant system.

### CROSS-REFERENCE TO RELATED APPLICATION(S)

This is a conversion of and claims a benefit of priority from U.S. Provisional Application No. 61/938,034, filed Feb. 10, 2014, entitled “SYSTEM, METHOD AND ARCHITECTURE FOR PROVIDING INTEGRATED APPLICATIONS,” which is fully incorporated herein for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates generally to electronic commerce (ecommerce). More particularly, embodiments disclosed herein relate to integrating third-party hosted applications to users of an ecommerce platform in an efficient and streamlined manner, thereby significantly enhancing user experience in interacting with the ecommerce platform.

### BACKGROUND OF THE RELATED ART

The term “ecommerce” generally refers to buying and selling products or services online over computer networks such as the Internet. An online ecommerce marketplace refers to a type of ecommerce site on the Internet where product information is provided by third-party merchants, retailers, businesses, sellers, etc. (hereinafter referred to as merchants) and consumer transactions are processed by the marketplace operator. In this context, the merchants are the customers of the marketplace operator. The marketplace operator provides its customers with access to various resources, including hardware, software, and people, via an ecommerce platform. In this disclosure, such customers are referred to as users of the ecommerce platform.

The ecommerce platform may include a plurality of tools configured for supporting a user to create and maintain a presence in the online ecommerce marketplace. The plurality of tools may include a website, a domain name, a secure shopping cart, a product catalog, a payment gateway, email accounts, marketing tools, a reporting tool, a mobile store, etc. The ecommerce platform may also provide a user with access to various applications such as accounting, marketing, and inventory management systems, etc. hosted by third-party application providers.

### SUMMARY OF THE DISCLOSURE

Embodiments disclosed herein are directed to a system, method, and architecture for providing applications hosted by third-party application providers to users of an ecommerce platform in an efficient and streamlined manner, thereby significantly enhancing user experience in interacting with the ecommerce platform.

In some embodiments, a system for providing integrated applications through an ecommerce platform may include an integrated applications container (IAC), an IAC proxy server, and an application registry. The IAC proxy server and the application registry may operate on one or more server machines. The IAC may be special software configured for running within a client application such as a browser executing on a client device communicatively connected to the IAC proxy server. In some embodiments, the IAC proxy server and the application registry may be communicatively connected to an authorization server configured for providing an authentication and authorization service which, in turn, may be communicatively connected to one or more third-party application providers.

In some embodiments, a method for integrating a third-party hosted application into a multi-tenant system may entail a two-click or a one-click installation process. In some embodiments, a two-click installation process may include an IAC receiving a first click from a user, the IAC embodied on non-transitory computer memory of a client device associated with the user, the user representing a tenant of the multi-tenant system, the first click associated with the third-party hosted application, the third-party hosted application hosted on a third-party application provider server external to and operating independently of the multi-tenant system. Responsive to the first click from the user, the IAC may call an IAC proxy server requesting installation of the third-party hosted application. The IAC proxy server may prepare and send an installation request to an application registry to begin the installation of the third-party hosted application, the application registry residing in the multi-tenant system, the installation request containing a user identifier associated with the user. Responsive to the installation request from the IAC proxy server, the application registry may return an object containing an authorization universal resource locator (URL) and an installation identifier for the installation of the third-party hosted application. The IAC proxy server establishing a connection between the client device and an authorization server and redirecting a browser application running on the client device to the authorization URL. Through a server window such as an iFrame in the browser application, the authorization server may receive a second click from the user, the second click identifying the third-party hosted application and indicating an authorization for the third-party hosted application to access resources of the multi-tenant system that are associated with the user. The authorization server may operate to obtain an access token from the third-party application provider server, for instance, by issuing temporary code in exchange for the access token, and communicating the authorization to the application registry. In turn, the application registry may update a data structure (for instance, setting a flag in an application registration database), indicating the completion of the installation of the third-party hosted application into the multi-tenant system.

In some embodiments, subsequent to calling the IAC proxy server requesting installation of the third-party hosted application, the IAC may regularly poll the IAC proxy server to obtain status information on the installation. Depending upon the installation status returned by the IAC proxy server, the IAC may take appropriate action such as displaying an error message should the installation fail. This polling by the IAC may continue until the application registry indicates that the third-party hosted application has been successfully installed or until the installation is terminated because, for instance, an authorization for the third-party hosted application could not be obtained.

In some embodiments, a single-click installation process may involve an authorization agent or service running on the client device. Specifically, when a user selects, through an electronic market place referred to as an app store, an application for installation, the app store may request a temporary authorization token from an authorization server. The authorization server may send a temporary authorization token and an authorization URL to the app store. The app store may communicate the received information to the authorization agent or service running on the client device. This causes the browser application running on the client device be redirected to the authorization URL (at the authorization server) with the temporary authorization token. The authorization server verifies the temporary authorization token and issues the authorization without requiring further user intervention. The authorization agent or service running in the browser application then issues an authorization callback to the application. The application sends a request to the authorization server for an access token and receives an access token, which allows the application to access the resources associated with the user, which is a tenant of the underlying multi-tenant system. This completes the single-click installation process.

One embodiment comprises a system having a processor and non-transitory computer memory including instructions translatable by the processor to perform a method substantially as described herein. Another embodiment comprises a computer program product having at least one non-transitory computer-readable storage medium storing instructions translatable by at least one processor to perform a method substantially as described herein.

Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of a high level network architecture in which some embodiments disclosed herein may be implemented;

FIG. 2 depicts a diagrammatic representation of an example graphical user interface illustrating an example installation in accordance with some embodiments;

FIG. 3 depicts a diagrammatic representation of an example graphical user interface illustrating an example installation in accordance with some embodiments;

FIG. 4 depicts a diagrammatic representation of an example graphical user interface illustrating an example installation in accordance with some embodiments;

FIG. 5 depicts a diagrammatic representation of an example graphical user interface illustrating an example installation in accordance with some embodiments;

FIG. 6 depicts a diagrammatic representation of components of an example system according to one embodiment;

FIG. 7A and FIG. 7B illustrate an example process flow in accordance with some embodiments;

FIG. 8 illustrates an example process flow in accordance with some embodiments;

FIG. 9 illustrates an example process flow in accordance with some embodiments; and

FIG. 10 illustrates an example process flow in accordance with some embodiments.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

As described above, an ecommerce platform may provide its users with access to various resources, including hardware, software, and people. Such an ecommerce platform may include a plurality of tools configured for supporting the users in creating and maintaining one or more stores in an online ecommerce marketplace within the ecommerce platform. The plurality of tools may include a website, a domain name, a secure shopping cart, a product catalog, a payment gateway, email accounts, marketing tools, a reporting tool, a mobile store, etc. Additionally, an ecommerce platform may provide its users with access to various applications such as accounting, marketing, and inventory management systems, etc. hosted by third-party application providers.

To significantly enhance user experience in interacting with an ecommerce platform, in some embodiments, system 100 may implement a two-click installation process for integrating a third-party hosted application. As will be explained in greater detail below, this process may involve an integrated applications container (IAC) running on a client device at the frontend and an IAC proxy server operating at the backend.

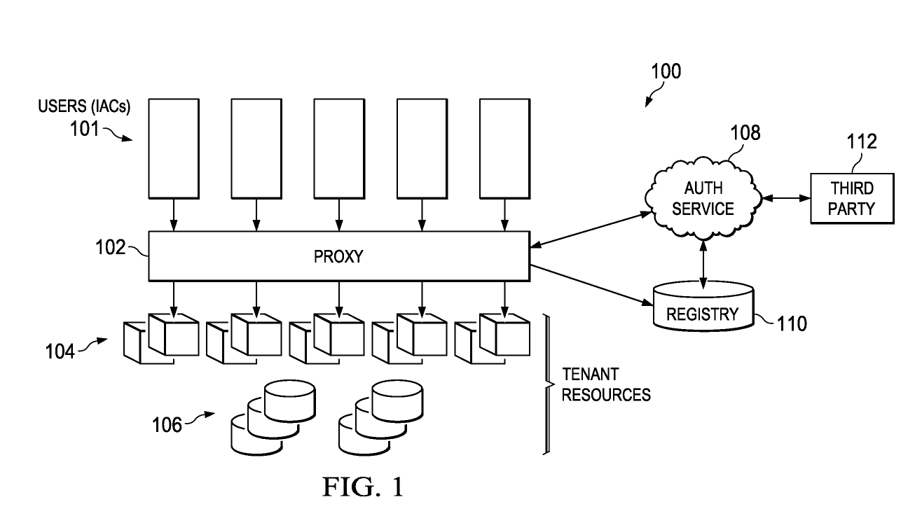

As illustrated in FIG. 1, system 100 may implement a multi-tenancy ecommerce architecture in which a single instance of the software running on a server machine can serve multiple client organizations (tenants). The server machine itself may reside or be hosted in a cloud computing environment. Each user of system 100 can access their resources (tenant resources) via a user interface of system 100 (e.g., a control panel, dashboard, etc.). Multi-tenancy architecture and cloud computing are known to those skilled in the art and thus are not further described herein.

In the example embodiment illustrated, shown in system 100 of FIG. 1 are users 101, integrated applications container (IAC) proxy 102, tenant resources 104, 106, authorization service 108, application registry 110, and third-party application providers 112. Those skilled in the art will appreciate that a user 101 may represent an individual user as well as hardware/software associated with that individual user, including, but are not limited to, a client device running an IAC.

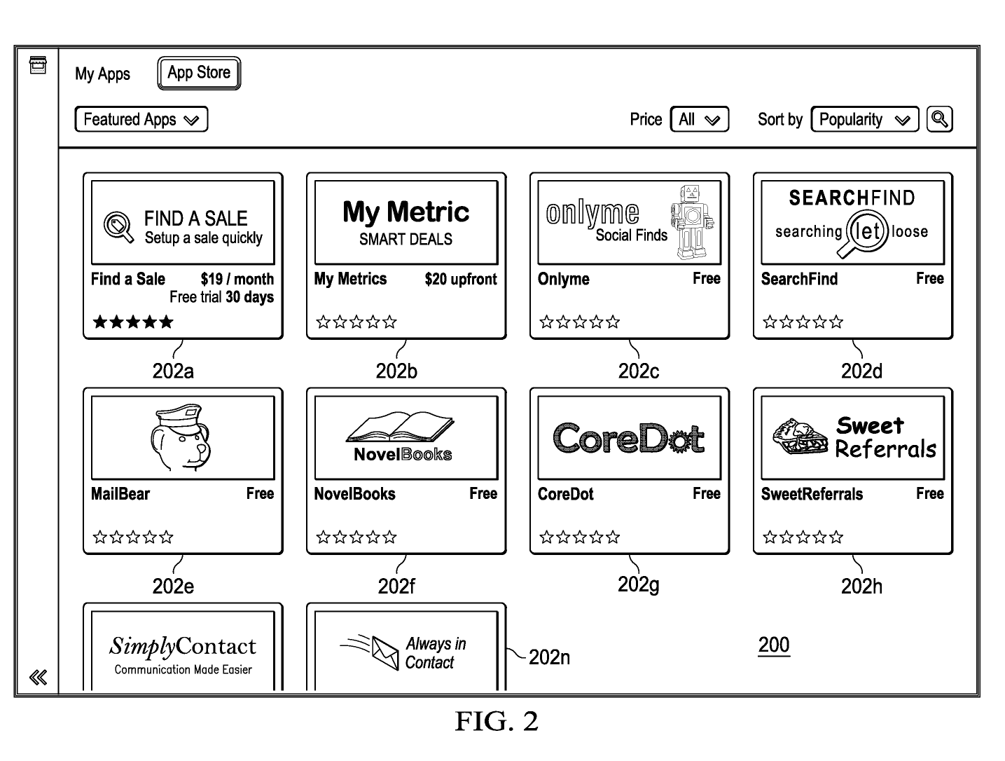

An IAC may refer to special software configured for communicating with IAC proxy server 102 and may include a special frontend user interface that enables users to install, manage, and/or browse third-party hosted applications. In this disclosure, third-party hosted applications refer to applications that are hosted on one or more server machines associated with one or more third-party application providers or developers 112 (which can be external to and independent of system 100) and that are available through a particular electronic commerce website or platform (also referred to as an “app store”) provided by system 100 (see, for instance app store 200 shown in FIG. 2). Those skilled in the art will also appreciate that a user may access the app store of system 100 through a web browser executing on a client device.

In one embodiment, an IAC may include control logic embodied in a control panel of the app store. Representations of integrated applications (hosted by third-party application providers) may reside within an IAC and presentable through the app store. In some embodiments, an IAC can be particularly configured for interacting with third-party hosted applications and automating installation of such third-party hosted applications.

In some embodiments, application information and installation information for third-party hosted applications may be stored in application registry 110. In some embodiments, IAC proxy server 102 is operable to manage requests and responses to and from IACs 101 and application registry 110. In some embodiments, application registry 110 may be communicatively connected to IAC proxy server 102 and authorization service 108. In some embodiments, authorization service 108 may be communicatively connected to third-party application providers 112 and authorization service 108. In some embodiments, authorization service 108 may provide an authentication and authorization service (via an application programming interface) to third-party hosted applications.

Through an IAC, a user of system 100 can browse, install, and manage one or more third-party hosted applications. Installation of such a third-party hosted application may require minimal efforts on the part of the user. For example, in some embodiments, the entire process of installing a third-party hosted application may require only two clicks by a user of system 100—a first click to select a third-party hosted application for installation and a second click to grant or authorize the selected application with access to tenant resources 104, 106 that are owned by user 101 and that are within system 100. The authorization information may be stored in registry 110 accessible by authorization service 108.

FIG. 2 depicts a screenshot of an example of app store 200 for users 101 of system 100. As illustrated, system 100 may present to users 101 (e.g., via an ecommerce platform including an app store) a plurality of applications 202a . . . 202n available for installation through system 100. In some embodiments, a method for integrating third-party hosted applications through an ecommerce platform may include a user clicking on a representation such as an icon or a box representing a particular application in the app store. As explained above, the user may interact with system 100 via a client device running an IAC communicatively connected to a server machine of system 100.

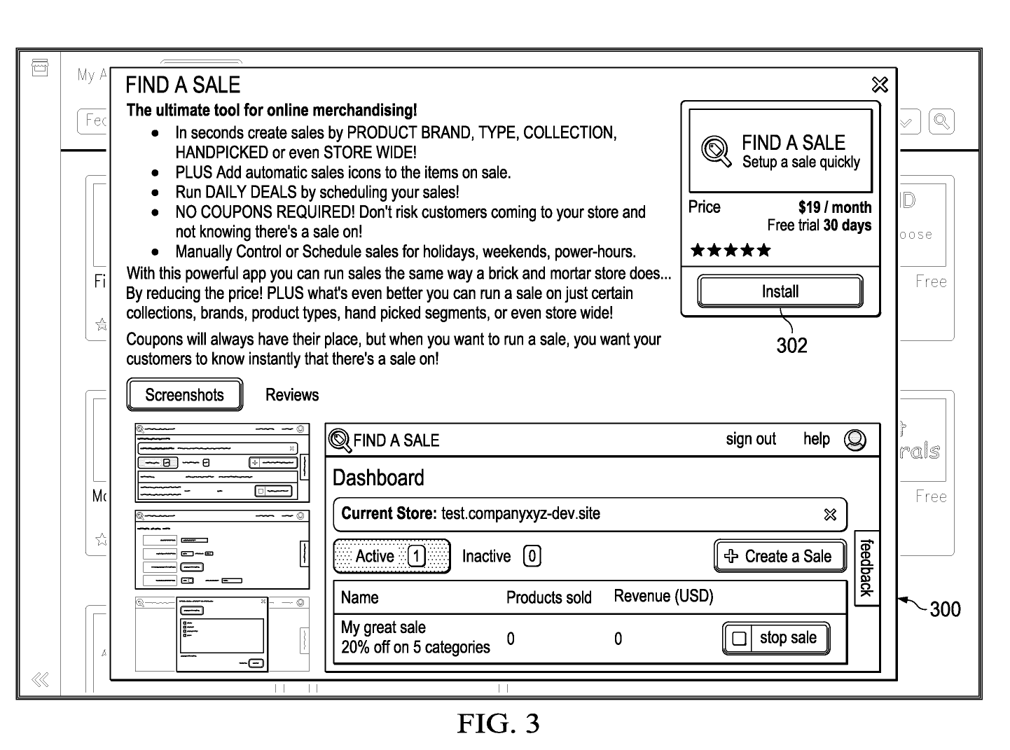

For the purpose of illustration, suppose a user selects application 202a, a window, an overlay, or a page associated with application 202a may be generated or otherwise obtained and displayed to the user. An example of application page 300 is shown in FIG. 3, where the user may review further details on the selected application. Suppose the user decides to install application 202a (such that application 202a, which is hosted by a third party, is integrated in system 100 for use by the user through system 100). In this example, in response to the user selecting a representation (e.g., a button) of installation function 302, IAC 101 may make a call (e.g., an AJAX call) to IAC proxy server 102 running on the server machine to trigger an installation of the particular user-selected application. IAC proxy server 102 may communicate with application registry 110 to register the new application in association with the user and return an object (e.g., a JSON object) to the IAC 101. The object from IAC proxy server 102 may contain an installation identifier (ID) and a universal resource locator (URL) referencing authorization service 108.

As an example, authorization service 108 may implement an open standard for authorization such as OAuth2. OAuth provides a process for users to authorize third-party application providers access to their server resources (in this example, tenant resources 104, 106 within system 100) using user-agent redirections without having to share their credentials such as a username and password pair.

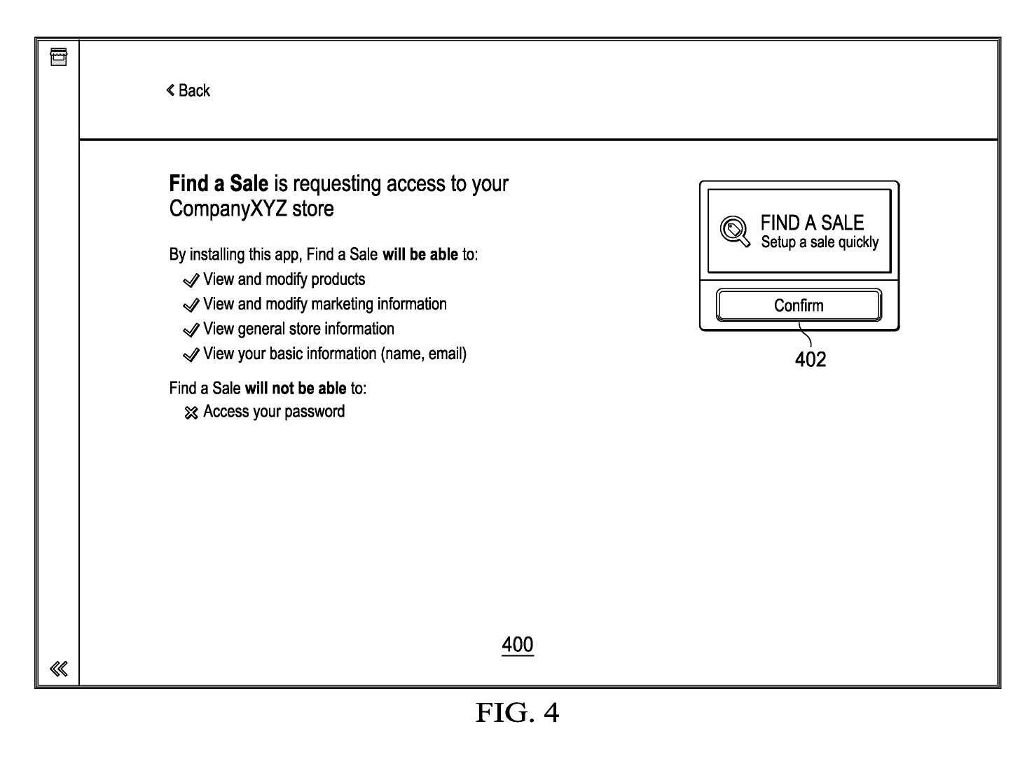

In some embodiments, IAC 101 may open an iFrame using the URL which references authorization service 108 and which is provided by IAC proxy server 102 so that the user can authorize the new application via a single click. FIG. 4 depicts a diagrammatic representation of an example of iFrame 400 in which the user can authorize (e.g., by selecting or clicking a single “Confirm” button 402) application 202a with access to tenant resources associated with the user within system 100. Thus, as the above example illustrates, to install application 202a, the user only needs to first click on the “Install” button 302 and then click on the “Confirm” button 402. This is referred to as a two-click installation process for integrating a hosted application.

IAC 101 may continuously poll IAC proxy server 102 to determine installation status (e.g., installing, success, failed, unauthorized, etc.). IAC 101 may do so using the installation ID provided by IAC proxy server 102. If the status returned from IAC proxy server 102 indicates that the installation is ongoing, IAC 101 may continue to poll IAC proxy server 102 (e.g., at a predetermined time interval, for instance). If the status returned from IAC proxy server 102 indicates that the installation is a success, IAC 101 may update the IAC user interface running on the client device to reflect the installation of the user-selected application. If the status returned from IAC proxy server 102 indicates that the installation has failed or is unauthorized (as indicated by the user), IAC 101 may generate an error message which is then displayed to the user.

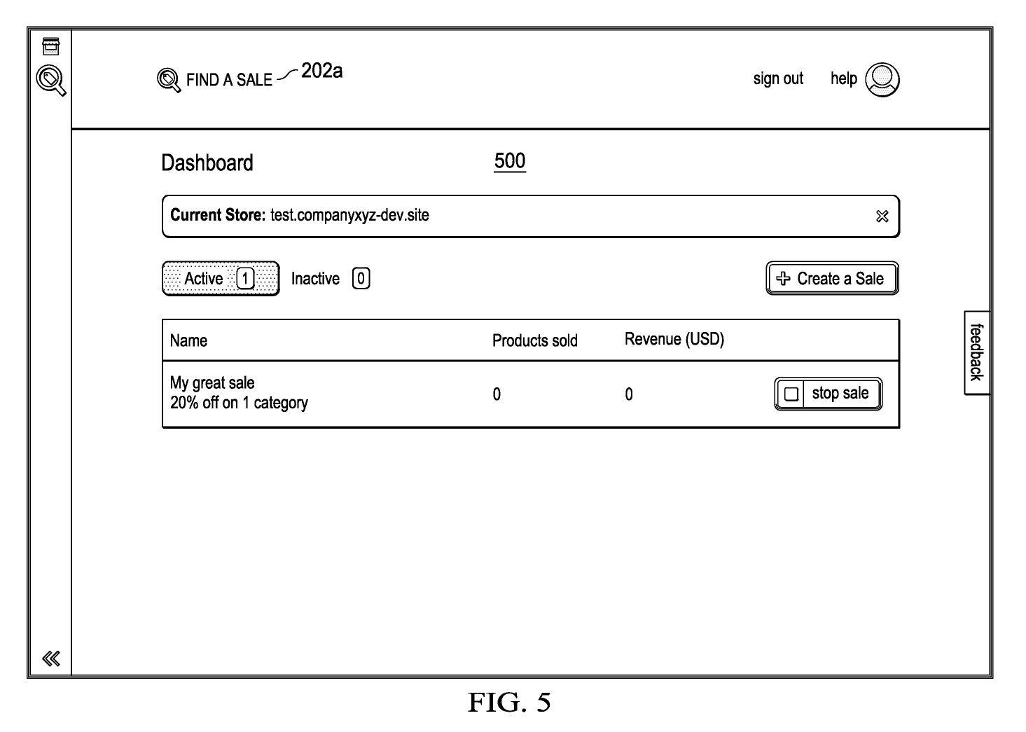

Suppose, for the purpose of illustration, the installation is a success. FIG. 5 depicts a diagrammatic representation of an example of dashboard 500 of application 202a with the user already signed in. The user can now proceed to utilize application 202a and application 202a has access to the user's resources within system 100.

As described above, embodiments disclosed herein enable a user to integrate third-party hosted applications with minimal efforts on the part of the user-no upfront registration/configuration efforts are required of the user. This significant improvement is achieved, in part, because all installation and authorization is built and invoked by an IAC. Third-party hosted applications may only need to provide a call back endpoint (e.g., a special URL) to exchange a piece of temporary code for an access token. Before going into details of exemplary methodologies, however, a few more definitions may be helpful.

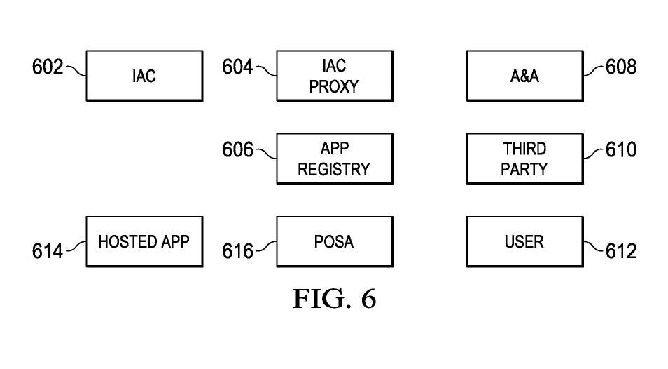

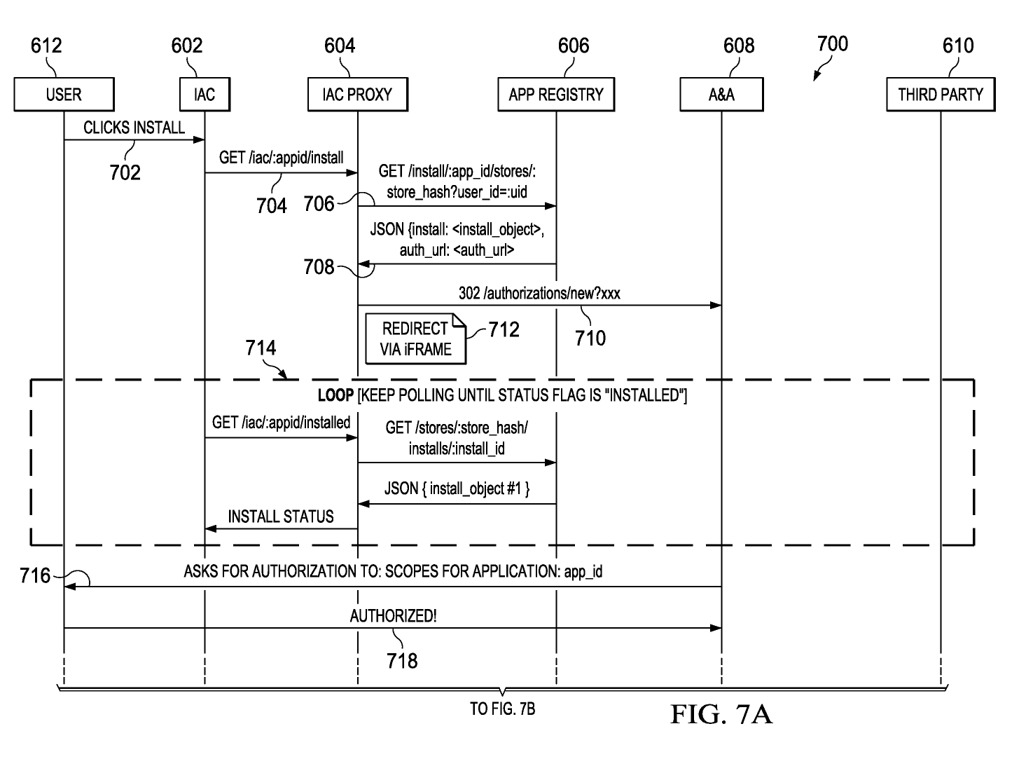

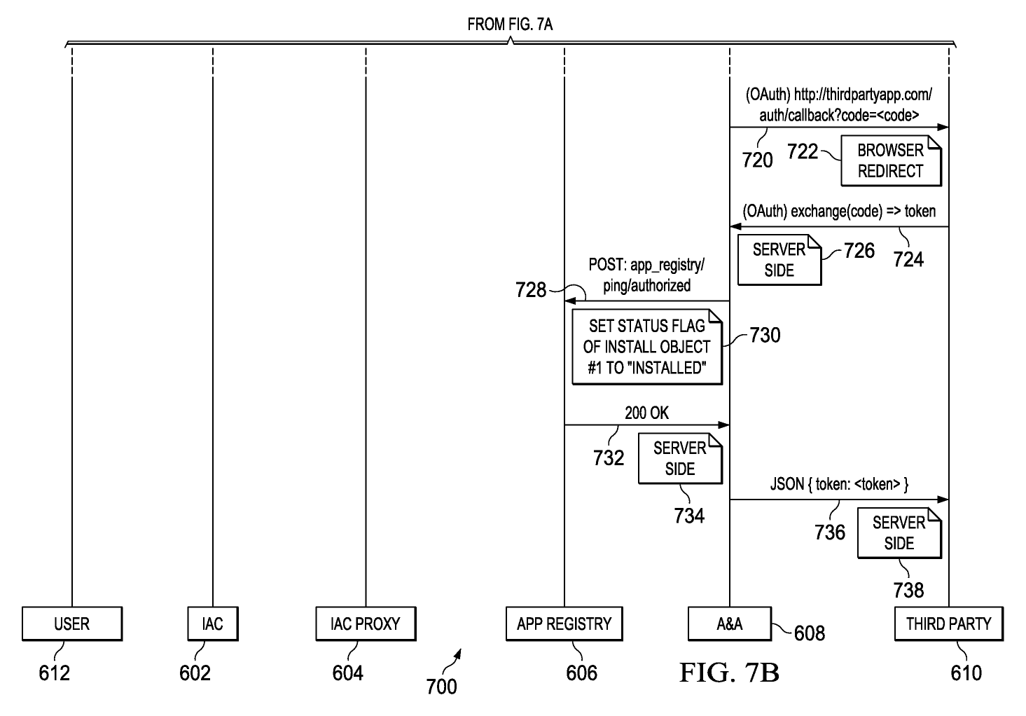

Referring to FIG. 6, shown are example entities that may be embodied in system 100 shown in FIG. 1 and utilized in implementing methods disclosed herein according to some embodiments. Such methods are discussed in greater detail with respect to FIGS. 7A-10.

Specifically, IAC 602 may be the same or similar to IAC 101 describe above; IAC proxy may be the same or similar to IAC proxy server 102 described above; authentication and authorization service (A&A) 608 may be the same or similar to authorization service 108 described above; application registry 606 may be the same or similar to application registry 110 described above; third-party application providers 610 may be the same or similar to third-party application providers 112 described above; hosted applications 614 may be the same or similar to third-party hosted applications described above; plain old store applications (POSA) 616 may refer to applications that are not installable via app store 200; and user 612 may refer to a tenant of system 100 having associated tenant resources 104, 106.

In some embodiments, IAC 602 may include a frontend user interface that can be used by user 612 to install, browse, and manage hosted applications 614. Turning now to FIG. 7, flow 700 illustrating installation of third-party hosted applications in accordance with embodiments is shown. At 702, user 612 may click on an install button from within a user interface of IAC 602. This causes IAC 602 to make a call to IAC proxy server 604, which communicates with application registry 606 to begin a process of installation, at 706. The install request may include a user identifier (user_id). At 708, application registry 606 returns a JSON object containing an authorization URL and an installation identifier (install_id) for the requested installation. At 710, IAC proxy server 604 establishes a connection with A&A 608 and, at 712, boots the authorization URL into an iFrame within the user interface of IAC 602 for the user to authorize the installation.

At 714, which may be a loop process in some embodiments, IAC 602 may regularly poll IAC proxy server 604 to determine the installation status. IAC proxy server 604 may prepare and send a query (e.g., a GET HTTP request) with the installation identifier to application registry 606. Application registry 606 may access the associated application information stored in the repository and provide a JSON object with the installation data to IAC proxy server 604. Depending upon when a poll is conducted in this process, status returned to IAC 602 from IAC proxy server 604 can include installing, success, failed, unauthorized, etc., as described above

An example of an authorization process is shown with regard to items 716-738. However, any suitable authorization and authentication process may be employed. In the example discussed, an OAuth2 process is illustrated.

At 716, A&A 608 may send, via the iFrame connection established by IAC proxy server 604, a request for authorization from user 612 to allow access by the particular application to the user's resources as described above. This request from A&A 608 may include, for example, a request for a scope of authorization and an identification of the particular application (app_id). In this example, user 612 may authorize the installation of the particular application by, for instance, selecting or clicking on an appropriate button on the user interface (see, e.g., FIG. 4). At 718, this authorization is communicated to A&A 608. In response, at 720, A&A 608 may send a call back to an endpoint at a third-party network address (e.g., an URL) associated with the particular application to exchange a piece of temporary code for an access token. This exchange may follow an open standard for authorization and authentication known as OAuth 2.0.

At 722, the user's browser may be redirected to the authorization URL. There, third-party application providers 610 may provide a token to A&A 608 at 724 (server side 726). At 728, A&A 608 may communicate the authorization result to application registry 606. At 730, application registry 606 may set the status flag of the application (in this example, “install_object #1”) as “installed.” Since the user (e.g., a merchant) had authorized the access, at 732, application registry 606 may provide an acknowledgement of the authorization to A&A 608 (server side 734). At 736, A&A 608 may use the particular token associated with the application to communicate with third-party application providers 610 (server side 738).

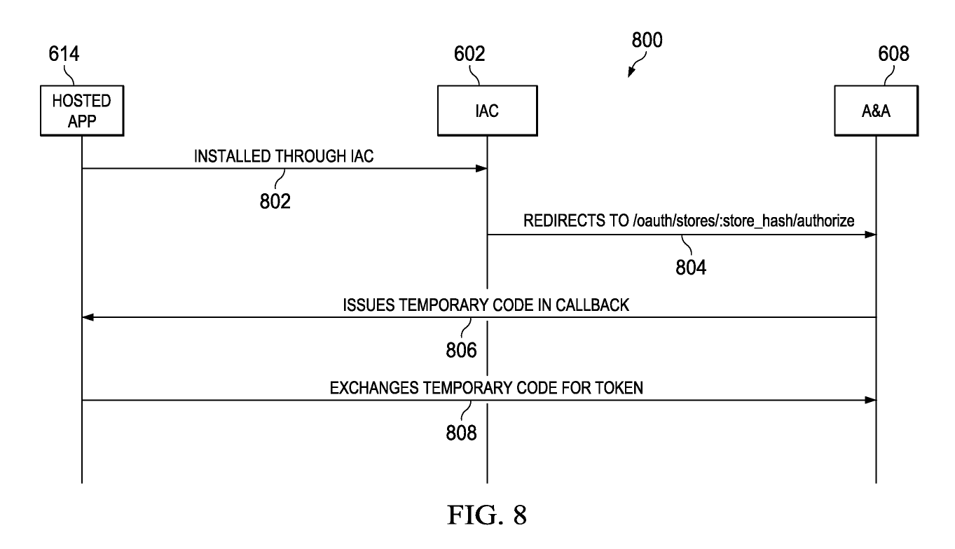

While flow 700 illustrates a non-limiting example of an OAuth 2.0 based implementation, FIG. 8 depicts flow 800 illustrating a client-side implementation of OAuth 2.0 which allows third-party application providers to interact with system 100. As compared to flow 700, flow 800 is significantly streamlined because IAC 602 tracks, at the client side, information for the app store (e.g., “store_hash”), tokens for third-party hosted applications, and context for the app store and passes the information to third-party hosted applications. In this way, third-party hosted applications may only need to handle the callback and thus does not need authorization scopes, which can be retrieved when its callback URL is invoked.

Specifically, at 802, third-party hosted application 614 is installed through IAC 602 running on a client device. Third-party hosted application 614 may support an authentication framework known as OmniAuth. In this scenario, third-party hosted application 614 does not need to have knowledge of the scopes of the authorization scopes.

Rather, information which is necessary to communicate with A&A 608 can be stored in non-transitory computer memory local to IAC 602. This may include a data structure storing information identifying an app store (e.g., app store 200). In some embodiments, the data structure may be a hash table storing key-value pairs referencing elements of app store 200, including a representation of third-party hosted application 614.

Accordingly, when third-party hosted application 614 is installed through IAC 602, IAC 602 may operate to prepare and send a corresponding query to A&A 608, at 804. The query may contain a hash value (e.g., a “store_hash”) identifying third-party hosted application 614 and an endpoint URL associated with third-party hosted application 614.

At 806, A&A 608 calls third-party hosted application 614 at the given URL with a piece of temporary code. This callback from A&A 608 to third-party hosted application 614 may include the authorization scope(s) and the context of the app store received in a query string from IAC 602.

At 808, third-party hosted application 614 can use the provided information (i.e., using the context parameter and passing through the received scope from the query parameters) to build a token URL and perform the exchange—exchanging the piece of temporary code with a special access token associated with third-party hosted application 614. IAC 602 may keep track of tokens issued by third-party hosted applications and store token aliases locally.

Some embodiments may allow for integration of standalone applications without IACs. This may occur when a user (e.g., a merchant who is a tenant of system 100) may have more than one online store operating on the ecommerce platform supported by system 100 and there may be a need to keep one access token per a third-party hosted application. In this case, custom authorization URLs may be needed.

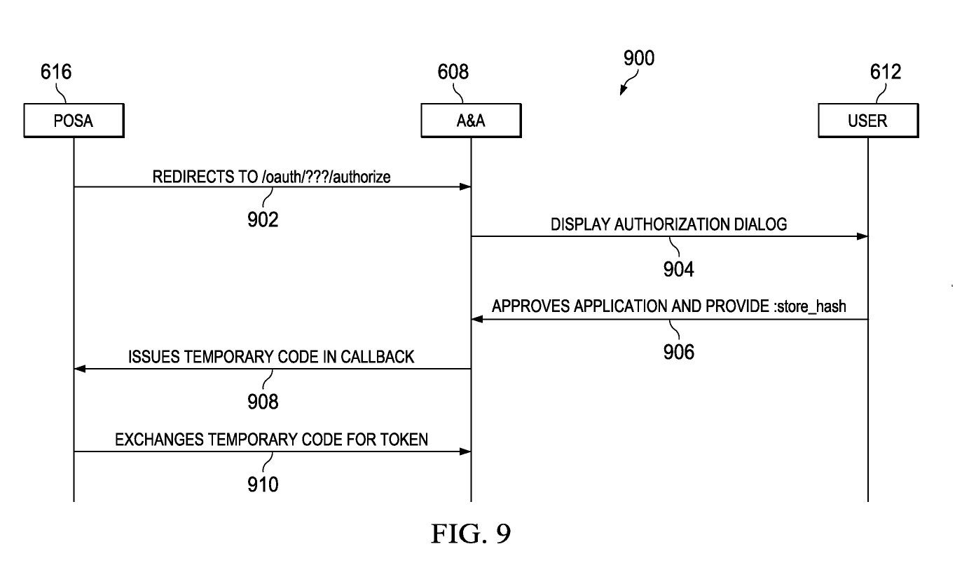

This is illustrated in flow 900 shown in FIG. 9. In this example, POSA 616 needs to know the authorization scope and the store_hash. POSA 616 can retrieve the scopes from documentation provided by system 100 and initialize an OmniAuth interface to use them. However, when POSA 616 is store agnostic, it has no way to retrieve the store_hash from anywhere. Thus, at 902, POSA 616 sends a custom authorization URL with scope aliases, a state token, and some context involving “stores” to A&A 608.

At 904, A&A 608 displays an authorization dialog to user 612 seeking authorization from user 612 to install POSA 616 for one of their stores. Using the authorization dialog, user 612 can provide the required store_hash to translate the aliased scopes and context for the authorization, at 906. In some embodiments, if user 612 has multiple stores and has already authorized a store or stores, the authorization dialog box may still be shown every time a standalone application requests for authorization to be included in one of their stores. User 612 will then be given a chance to choose an appropriate target store.

A&A 608 may receive the scopes and context, create a new authorization and temporary code, and call POSA 616 back, at 908. This passes the scope in its alias form and the context in the query string. POSA 616 can use the context parameter to build an access token URL and return same in exchange for the temporary code, at 910, passing through the received scope from the query parameters.

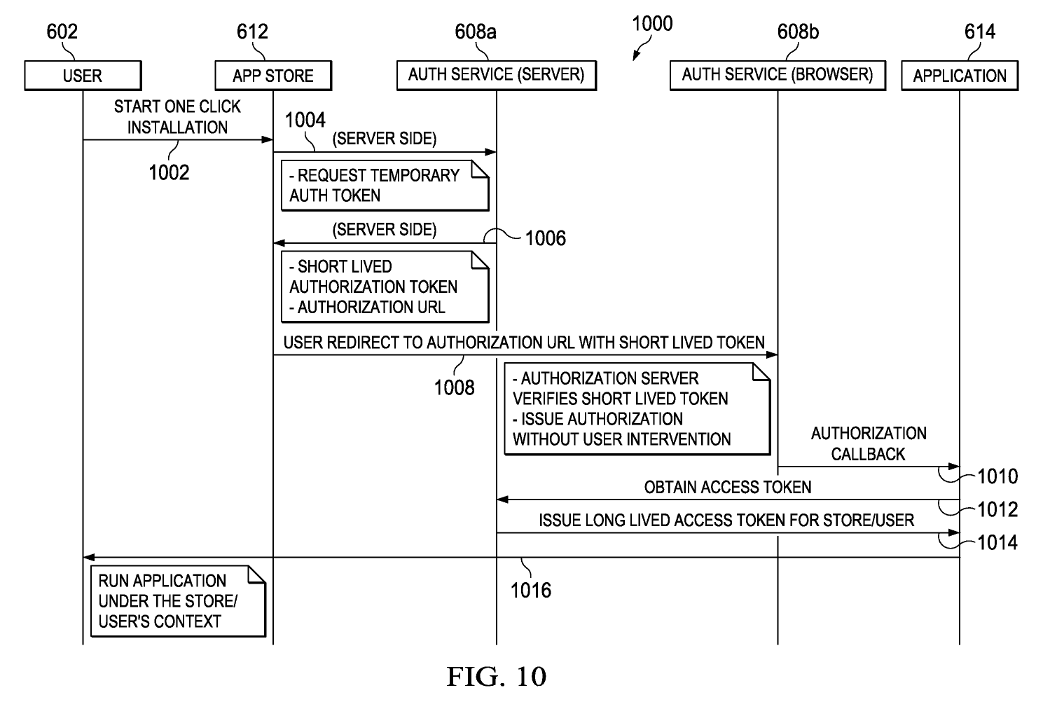

Some embodiments may allow a user to install a hosted application within an online store (which is associated with the user and which operates on the ecommerce platform) via a single click, with no upfront registration/configuration effort on the part of the user. The act of installing the application grants the application with access to resources which are owned by the user and within the ecommerce platform. This process is distinct from the traditional web based installation flows in that it occurs from a single click, without prompting the user for credentials, permissions or any form of user intervention. For example, instead of opening an iFrame requesting user authorization as described above, some embodiments may issue a temporary token on behalf of the user. One example of this single click installation process to integrate a hosted application is illustrated FIG. 10.

In this example, flow 1000 may involve user 602, app store 612, A&A server 608a, A&A service (via a browser running on a client device associated with user 602) 608b, and application 614 which is available through app store 612. In some embodiments, app store 612 may be hosted on an application server operating in system 100.

Flow 1000 may begin at 1002, when user 602 selects the one click installation of application 614 through app store 612. In response, app store 612 requests a temporary authorization token from A&A server 608a, at 1004. At 1006, A&A server 608a sends a short lived, temporary authorization token and the authorization URL to app store 612. App store 612 communicates same to A&A service 608b, which causes the browser be redirected to the authorization URL with the short lived token, at 1008. A&A server 608a verifies the short-lived token and issues the authorization without requiring further user intervention. A&A service 608b running in the browser then issues an authorization callback to application 614, at 1010. At 1012, Application 614 sends a request to A&A server 608a for an access token and receives a long lived access token, at 1014. At 1016, application 614 is run under the store/user's context, thus completing single-click installation flow 1000.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be embodied on distributed, or networked systems which may include hardware components and/or circuits. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A method for integrating a third-party hosted application into a multi-tenant system, comprising:
an integrated applications container (IAC) receiving a first click from a user, the IAC embodied on non-transitory computer memory of a client device associated with the user, the user representing a tenant of the multi-tenant system, the first click associated with the third-party hosted application, the third-party hosted application hosted on a third-party application provider server external to and operating independently of the multi-tenant system;
responsive to the first click from the user, the IAC calling an IAC proxy server requesting installation of the third-party hosted application;
the IAC proxy server preparing and sending an installation request to an application registry to begin the installation of the third-party hosted application, the application registry residing in the multi-tenant system, the installation request containing a user identifier associated with the user;
responsive to the installation request from the IAC proxy server, the application registry returning an object containing an authorization universal resource locator (URL) and an installation identifier for the installation of the third-party hosted application;
the IAC proxy server establishing a connection between the client device and an authorization server and redirecting a browser application running on the client device to the authorization URL;
the authorization server receiving a second click from the user, the second click identifying the third-party hosted application and indicating an authorization for the third-party hosted application to access resources of the multi-tenant system that are associated with the user;
the authorization server obtaining an access token from the third-party application provider server and communicating the authorization to the application registry; and
the application registry updating a data structure to indicate completion of the installation of the third-party hosted application into the multi-tenant system.

2. The method according to claim 1, wherein redirecting the browser application running on the client device to the authorization URL includes opening a server window within the browser application running on the client device using the connection between the client device and the authorization server.

3. The method according to claim 1, further comprising:
the IAC polling the IAC proxy server to obtain status information on the installation until the installation of the third-party hosted application into the multi-tenant system is completed or terminated.

4. The method according to claim 3, wherein the status information comprises installing, success, failed, or unauthorized.

5. The method according to claim 4, wherein an error message is displayed if the status returned from the IAC proxy server indicates that the installation has failed or is unauthorized.

6. The method according to claim 1, wherein obtaining the access token from the third-party application provider server comprises the authorization server issuing temporary code and invoking a callback URL at the third-party application provider server to exchange the temporary code with the access token.

7. The method according to claim 1, wherein the IAC receives the first click from the user via an online application store of the multi-tenant system and wherein the third-party hosted application is one of a plurality of third-party hosted applications available to the user through the online application store of the multi-tenant system.

8. A system, comprising:
an integrated applications container (IAC) embodied on non-transitory computer memory and configured for receiving a first click from a user, the user representing a tenant of a multi-tenant system, the first click associated with a third-party hosted application, the third-party hosted application hosted on a third-party application provider server external to and operating independently of the multi-tenant system;
an IAC proxy server configured for, responsive to receiving a call from the IAC requesting installation of the third-party hosted application, preparing and sending an installation request, the installation request containing a user identifier associated with the user; and
an application registry embodied on non-transitory computer memory and configured for, responsive to the installation request from the IAC proxy server, preparing and returning an object containing an authorization universal resource locator (URL) and an installation identifier for the installation of the third-party hosted application;
wherein the IAC proxy server is further configured for establishing a connection between the client device and an authorization server and redirecting a browser application running on the client device to the authorization URL;
wherein the authorization server is operable to receive a second click from the user, the second click identifying the third-party hosted application and indicating an authorization for the third-party hosted application to access resources of the multi-tenant system that are associated with the user;
wherein the authorization server is operable to obtain an access token from the third-party application provider server and communicate the authorization to the application registry; and
wherein the application registry is further configured for updating a data structure to indicate completion of the installation of the third-party hosted application into the multi-tenant system.

9. The system of claim 8, wherein redirecting the browser application running on the client device to the authorization URL includes opening a server window within the browser application running on the client device using the connection between the client device and the authorization server.

10. The system of claim 8, wherein the IAC is further configured for polling the IAC proxy server to obtain status information on the installation until the installation of the third-party hosted application into the multi-tenant system is completed or terminated.

11. The system of claim 10, wherein the status information comprises installing, success, failed, or unauthorized.

12. The system of claim 11, wherein an error message is displayed if the status returned from the IAC proxy server indicates that the installation has failed or is unauthorized.

13. The system of claim 8, wherein obtaining the access token from the third-party application provider server comprises the authorization server issuing temporary code and invoking a callback URL at the third-party application provider server to exchange the temporary code with the access token.

14. The system of claim 8, wherein the IAC receives the first click from the user via an online application store of the multi-tenant system and wherein the third-party hosted application is one of a plurality of third-party hosted applications available to the user through the online application store of the multi-tenant system.

15. A method for integrating a third-party hosted application into a multi-tenant system, comprising:
an application server receiving a first click from a client device associated with a user, the application server operating in the multi-tenant system, the user representing a tenant of the multi-tenant system, the first click requesting installation of the third-party hosted application, the third-party hosted application hosted on a third-party application provider server external to and operating independently of the multi-tenant system;
responsive to receiving the first click from the user, the application server sending a request for authorization to an authorization server;
responsive to receiving the request for authorization from the application server, the authorization server sending a temporary authorization token and an authorization universal resource locator (URL) to the application server;
the application server communicating with an authorization agent running on the client device and sending the temporary authorization token and the authorization URL to the an authorization agent;
the authorization agent causing a browser application running on the client device be redirected to the authorization URL at the authorization server with the temporary authorization token;
the authorization server verifying the temporary authorization token and issuing an authorization;
the authorization agent issuing an authorization callback to the third-party hosted application;
the third-party hosted application sending a request to the authorization server; and
the third-party hosted application receiving an access token from the authorization server, the access token allowing the third-party hosted application to access resources in the multi-tenant system that are associated with the user.

16. The method according to claim 15, wherein the authorization agent runs within the browser application.

17. The method according to claim 15, wherein the application server receives the first click from the client device via an online store hosted on the application server.

18. The method according to claim 15, wherein the authorization server issues the authorization on behalf of the user without requiring the user to take any action.

19. The method according to claim 15, wherein subsequent to receiving the first click, the installation of the third-party hosted application occurring entirely within the multi-tenant system at server side.

20. The method according to claim 15, wherein subsequent to the installation, the third-party hosted application running in the multi-tenant system in a context associated with the user.
